(19) United States
(12) Patent Application Publication
(10) Pub. No.: US 2015/0035653 A1
(43) Pub. Date: Feb. 5, 2015

(54) Method and System for Storing Information Related to an Object

(71) Applicant: Ross Brent Harden, Cumberland (CA)

(72) Inventor: Ross Brent Harden, Cumberland (CA)

(73) Assignee: THE LEGACY CHIP CORPORATION, Ottawa (CA)

(21) Appl. No.: 14/012,271

(22) Filed: Aug. 28, 2013

Related U.S. Application Data
(63) Continuation of application No. PCT/CA2013/000685, filed on Aug. 2, 2013.

(51) Int. Cl. G06K 7/10; G06F 17/30

(52) U.S. Cl. CPC G06K 7/10366; G06F 17/30312; G06F 17/30386
USPC 340/10.42

(57) ABSTRACT

A method for storing information related to an object. An identification tag for being attached to the object is provided. The identification tag comprises identification data. A database for storing therein information related to the object is provided. The information is associated with the identification data. A reader for retrieving the identification data from the identification tag is provided. The identification tag is attached to the object. Using the reader the identification data are retrieved from the identification tag. The identification data and the information related to the object are provided. The information related to the object is stored in the database.

This application claims priority to and is a continuation of PCT Application PCT/CA2013/000685, entitled METHOD AND SYSTEM FOR STORING INFORMATION RELATED TO AN OBJECT, in the name of The Legacy Chip Corporation with Ross Brent Harden as the inventor, filed on Aug. 2, 2013, the entire contents of which are hereby incorporated by reference.

### FIELD

The present invention relates to storage of information related to an object, and more particularly to a method and system for storing information related to an object that links the information to the object.

### BACKGROUND

At present there is an increasing demand in discovering and preserving family histories. In particular, heirloom objects such as, for example, works of art, jewelry, furniture, china, glass ware, to name a few, are collected and handed down over generations. Typically, one generation tells a following generation—for example, parent to children or grandparents to grandchildren—stories about their lives and their possessions. Unfortunately, most of this information is handed down orally and is never documented.

Existing family writing heirloom programs help individuals to share their stories and to create an archive of their heirlooms. Typically, the archive comprises pictures of the heirloom items and written text, audio and video files, or a combination thereof.

Unfortunately, the existing family writing heirloom programs do not provide a direct link between a physical heirloom object and the documented information making it difficult to relate a specific heirloom object to the documented information, for example, in case of insufficient picture or video documentation. Furthermore, relating an object to the documented information can be very tedious and time consuming if there is no direct link therebetween, for example, when an estate is settled or a household dissolved.

It is desirable to provide a method and system for storing information related to an object that links the information to the object.

It is also desirable to provide a method and system for storing information related to an object that links the information to the correct object in a substantially reliable fashion.

### SUMMARY

Accordingly, one object of the present invention is to provide a method and system for storing information related to an object that links the information to the object.

Another object of the present invention is to provide a method and system for storing information related to an object that links the information to the correct object in a substantially reliable fashion.

According to one aspect of the present invention, there is provided a method for storing information related to an object. An identification tag for being attached to the object is provided. The identification tag comprises identification data. A database for storing therein information related to the object is provided. The information is associated with the identification data. A reader for retrieving the identification data from the identification tag is provided. The identification tag is attached to the object. Using the reader the identification data are retrieved from the identification tag. The identification data and the information related to the object are provided. The information related to the object is stored in the database.

According to another aspect of the present invention, there is provided a system for storing information related to an object. The system comprises an identification tag for being attached to the object. The identification tag comprises identification data. The system further comprises a reader for retrieving the identification data from the identification tag and a database for storing therein information related to the object with the information being associated with the identification data. A processor is in communication with the reader and the database. A user interface is in communication with the processor. A non-transitory storage medium has stored therein executable commands for execution on the processor. The processor when executing the commands receives the identification data from the reader; receives the information related to the object from the user interface; and associates the information related to the object with the identification data and providing the same to the database for storage therein.

One advantage of the present invention is that it provides a method and system for storing information related to an object that links the information to the object.

A further advantage of the present invention is that it provides a method and system for storing information related to an object that links the information to the correct object in a substantially reliable fashion.

### BRIEF DESCRIPTION OF THE DRAWINGS

One embodiment of the present invention is described below with reference to the accompanying drawings, in which:

FIGS. 1a and 1b are simplified block diagrams illustrating objects having identification tags attached thereto in a system for storing information related to an object according to one embodiment of the invention;

FIG. 1c is a simplified block diagram illustrating a RFID tag of the system for storing information related to an object according to one embodiment of the invention;

FIG. 1d is simplified block diagram illustrating the system for storing information related to an object according to one embodiment of the invention;

FIG. 1e is a simplified block diagram illustrating an active RFID reader of the system for storing information related to an object according to one embodiment of the invention;

FIGS. 2a to 2c are simplified flow diagrams illustrating a method for storing information related to an object according to one embodiment of the invention; and

FIGS. 3a to 3e are simplified block diagrams illustrating data structures used for implementing the method for storing information related to an object according to one embodiment of the invention.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

While embodiments of the invention will be described for storing family heirloom information, it will become evident to those skilled in the art that the embodiments of the invention are not limited thereto, but are also adaptable for various other types of applications such as, for example, storing and archiving objects in museums or documenting information related to works of art.

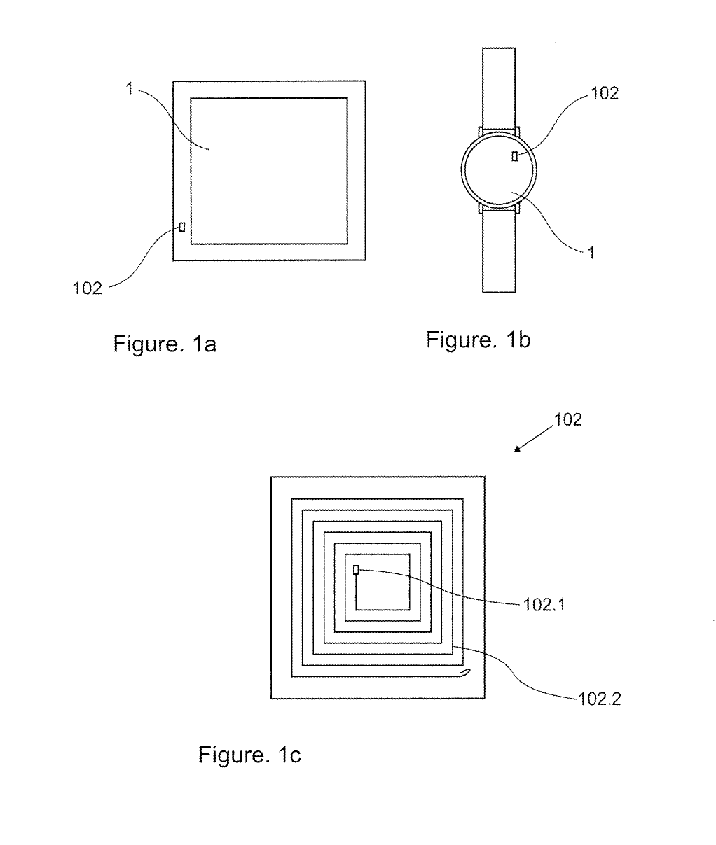

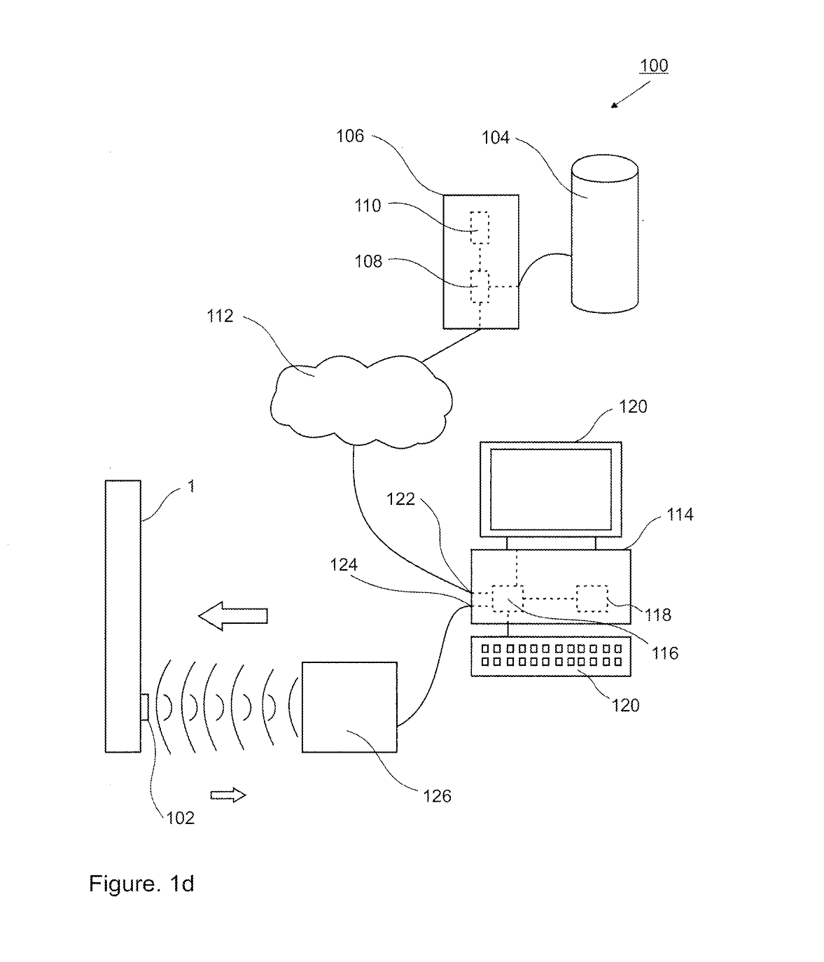

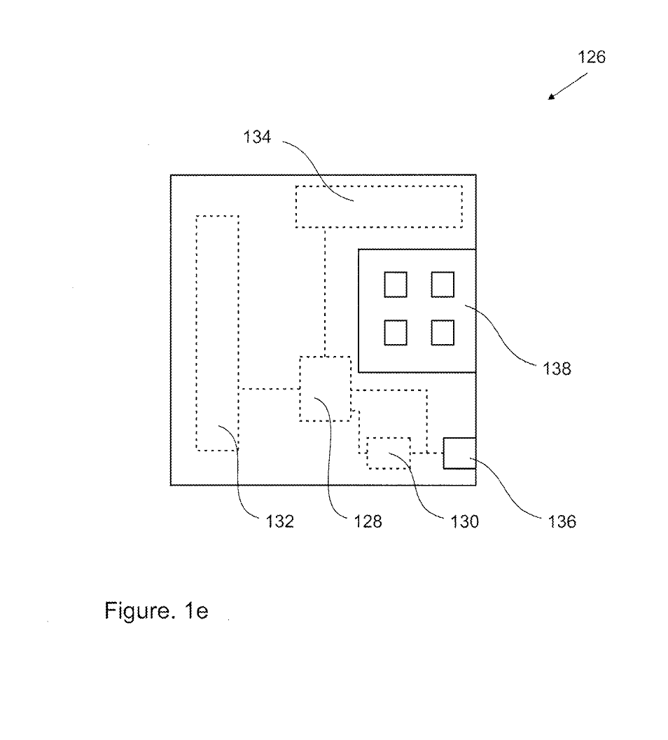

Referring to FIGS. 1a to 1e, a system 100 for storing information related to an object according to one embodiment of the invention is provided. The system 100 comprises a data processing unit 106 in data communication with database 104. The data processing unit 106 and the database 104 may belong to a trusted entity having safeguards in place to ensure long-term operation thereof For example, data processing and data storage is performed using backup systems placed in different locations while financial stability of the entity over generations is ensured via a trust fund. The data processing unit 106—comprising processor 108 and non-transitory storage medium 110—is connected to client computer 114—comprising processor 116, non-transitory storage medium 118, ports 122 and 124, and user interface 120—belonging to a user of the services provided by the trusted entity, via a computer network 112 such as, for example, the Internet. While the client computer 114 is illustrated in FIG. 1d in the form of a Personal Computer (PC), it will become evident to one skilled in the art that other types of computers such as, for example, smart phones and tablet computers are also employable. The system 100 further comprises identification tags 102 and reader 126. For example, the user is provided with the reader 126 and a set of the identification tags 102 after opening an account for accessing the services of the trusted entity, while further identification tags 102 can be purchased at a prize that includes a contribution to the trust fund. The system 100 for storing information related to an object and the method for storing information related to an object described hereinbelow are implemented using, for example, standard computer technology, standard web-based data communication technology, and standard query language technology.

The identification tags 102 can be passive Radio Frequency Identification (RFID) tags and the reader 126 is an active RFID reader. For example, the passive RFID tag 102 comprises chip 102.1 having a processor in communication with a non-transitory storage medium surrounded by antenna 102.2. Numerous types of passive RFID tags and active RFID readers are commercially available for various applications such as, for example, tracking objects during manufacture and distribution. Passive RFID tags are available as small as 2×2 mm including a built-in antenna. For example, the Talon Integrated RTLS tag manufactured by Tangent is of such a size and comprises a 128 bit read-only memory, sufficient for storing identification data such as an identification number. Passive RFID tags can be useful since they don't comprise a battery limiting the lifetime of the RFID tag.

As illustrated in FIG. 1e, the active RFID reader 126 typically comprises processor 128 connected to: non-transitory storage medium 130, antenna 132, power source 134, and port 136. Operation of the active RFID reader 126 is performed by the processor 128 executing commands stored in the storage medium 130. For example, after receiving a signal via the port 136 the processor 128 generates RF signal data which are provided to the antenna 132 for transmission therefrom. After receipt of an RF signal from the passive RFID tag 102 via the antenna 132 the processor 128 generates a data signal indicative of the identification data and provides the same via port 136 to the client computer 114. The power source 134 is provided, for example, as a rechargeable battery or an AC adapter. The port 136 is, for example, a USB port and is connected to the port 124 via a USB cable. Alternatively, the ports 136 and 124 are adapted for wireless communication using, for example, “WiFi” or “Bluetooth” technology.

In operation, the active RFID reader emits, via the antenna 132, a RF signal which is received by the antenna 102.2 of the RFID tag 102. The RF signal energizes the antenna 102.2 of the RFID tag 102 and sends a signal to the processor requesting retrieval of the data stored in the memory thereof—indicated by the large block arrow in FIG. 1d. In response, the processor retrieves the data and sends a signal to the antenna 102.2 for transmission therefrom—indicated by the small block arrow in FIG. 1d—which is received by the antenna 132 of the active RFID reader 126. For example, the Talon Integrated RTLS tag is designed to receive a 5.8 GHz RF signal and is able to communicate with the active RFID reader 126 at a distance of up to 2 m. Typically, in near field communication the transmission of power and signals between the active RFID reader 126 and the passive RFID tag 102 is based on inductive coupling. Alternatively, other RF technologies are employed based, for example, on backscattering or Surface Acoustic Waves (SAW). The operation of the active RFID reader 126 is controlled via commands received from the client computer 114 or, alternatively, via a user interface 138 disposed in a housing of the active RFID reader 126.

The passive RFID tags 102 are provided, for example, as labels having a suitable adhesive such as a pressure sensitive adhesive disposed on a bottom surface thereof for attaching the same to an object 1. Alternatively, the passive RFID tags 102 are encased in a housing made of a suitable plastic material which is attached to the object 1 using, for example, screws or wires for attaching the same to a fabric material.

The passive RFID tag 102 enables attachment of the same to various objects 1 in a substantially concealed fashion, for example, on the backside of the frame of a painting, as illustrated in FIG. 1a, while its small size enables attachment to small objects 1 such as a watch, as illustrated in FIG. 1b, or jewelry.

Alternatively, the identification tags 102 are provided as, for example, barcode tags or matrixcode tags with the corresponding reader being, for example, a laser scanner. Optionally, the camera of a smart phone is employed for capturing an image of the tag and providing the same to the processing unit 106. Further optionally, the tags are provided as tag image data which are printed by the user onto readily available labels.

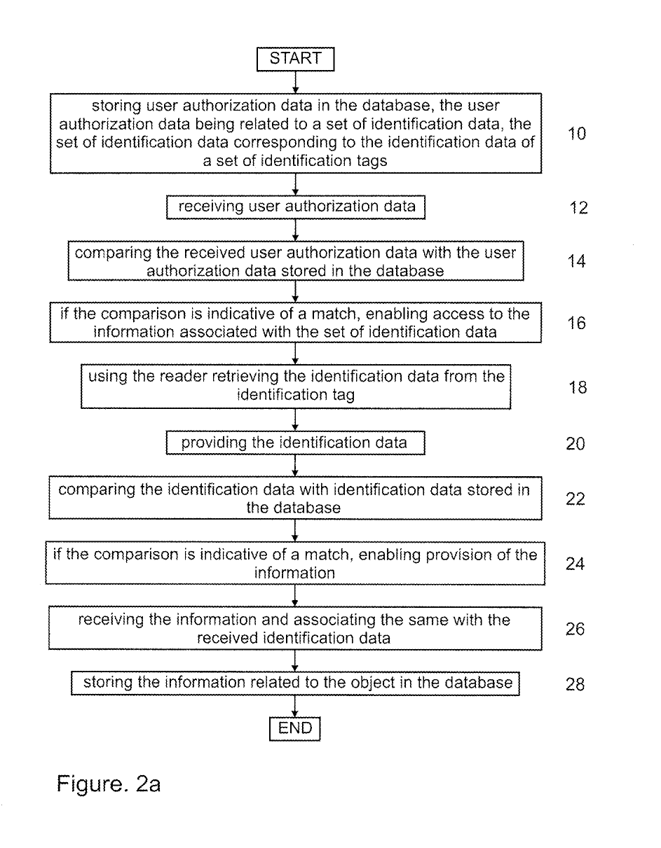

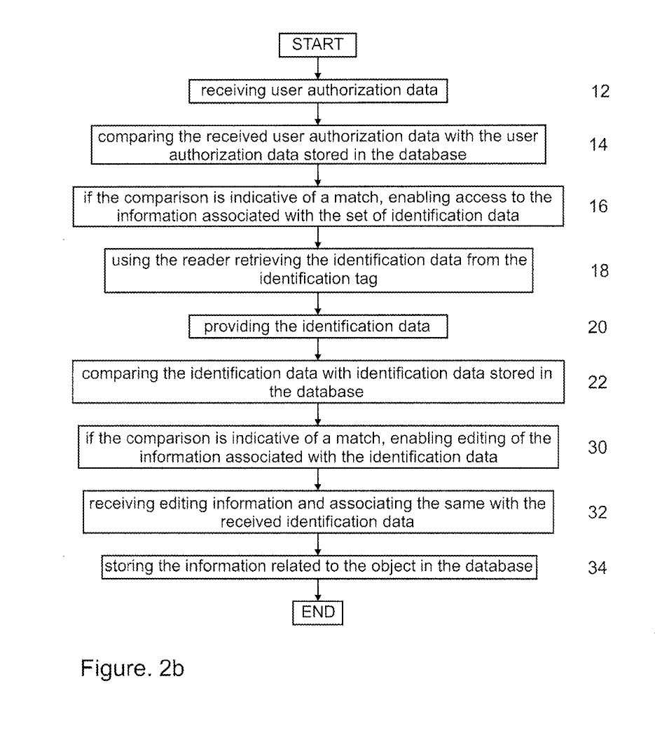

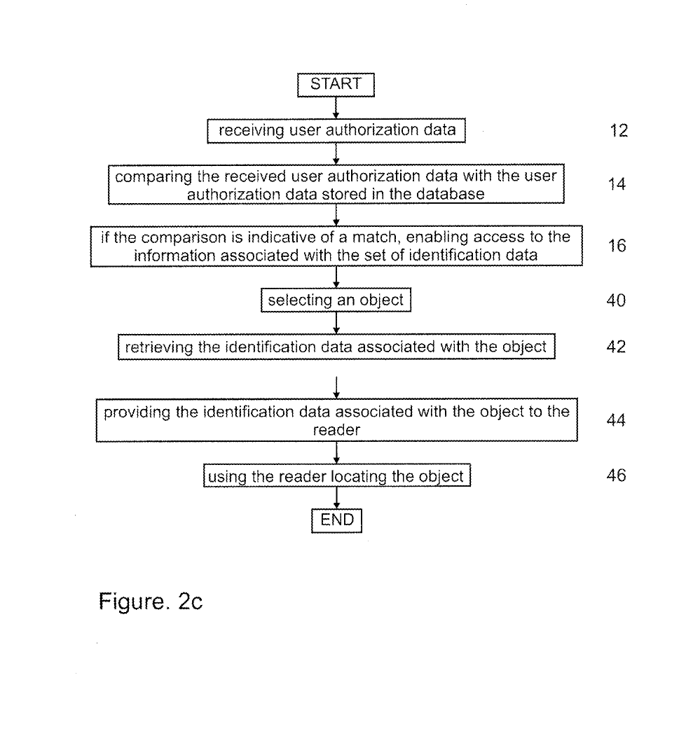

Referring to FIGS. 2a and 2b, a method for storing information related to an object according to another embodiment of the invention is provided. When opening an account with the trusted entity, user authorization data such as, for example, a password, a pin number, or biometric data indicative of the user are stored—at 10—in the database 104 associated with the account. The user authorization data are associated with a set of identification data related to a set of corresponding identification tags 102 which are then sent to the user. After receipt of the set of identification tags 102, the user attaches the same to the objects 1 such as, for example, family heirlooms, antiques, works of art, sports memorabilia, etc. for which the user desires to store information related thereto. In order to access the account, the user provides—at 12—the authorization data via the user interface 120 which is then provided to the processor 108. At 14, the processor 108 compares the received user authorization data with the user authorization data stored in the database 104 and if the comparison is indicative of a match, enables—at 16—access to the information associated with the set of identification data. Using the reader 126, the user retrieves the identification data from the identification tag 102—at 18—and provides the same—at 20—to the processor 108. Upon receipt, the processor 108 compares—at 22—the identification data with the identification data stored in the database 104 and if the comparison is indicative of a match, enables—at 24—provision of the information. The user then provides the information related to the object 1 associated with the identification data via the user interface 120 and upon receipt the processor 108 associates the same with the received identification data—at 26—and provides the information related to the object to the database for storage therein—at 28. The identification data can be unique for each identification tag 102 and provided in an obfuscated fashion. Optionally, the identification data are stored in the identification tag 102 and are transmitted in an encoded fashion. For example, use of an error correcting code such as, for example, a Reed-Solomon code or a Hamming code, enables retrieval of the identification data in case of errors occurring during data transmission or due to aging of the RFID tag 102.

In order to enable editing of the already stored information related to an object, the steps 12 to 22 are repeated followed by step 30 enabling editing of the information associated with the identification data, if the comparison is indicative of a match, as illustrated in FIG. 2b. The received editing information is then associated with the received identification data—at 32—and provided to the database 104 for storage therein—at 34. Repetition of the steps 12 to 22 before enabling editing of the information related to an object in concert with the provision of unique and obfuscated identification data ensure that the editing information provided is linked to the correct object in a substantially reliable fashion.

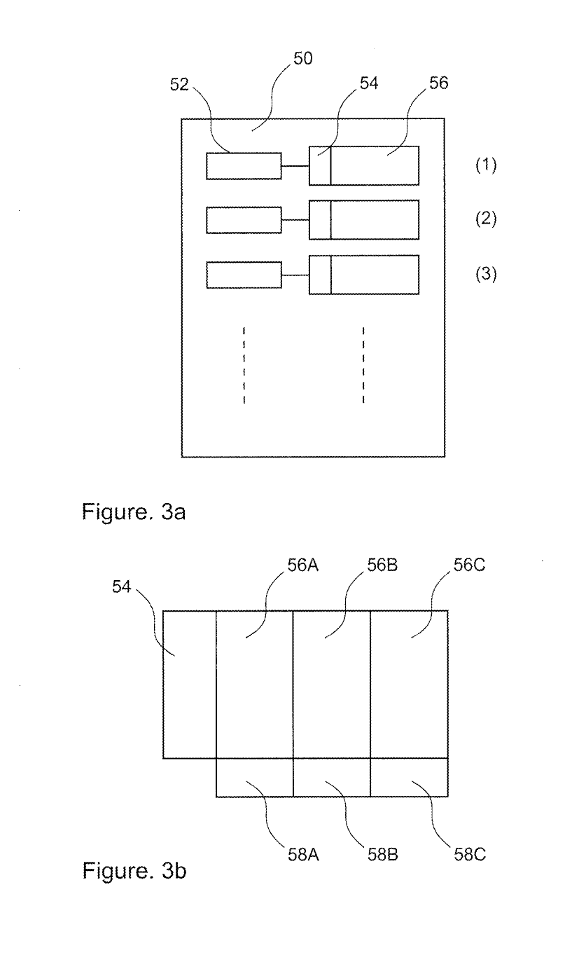

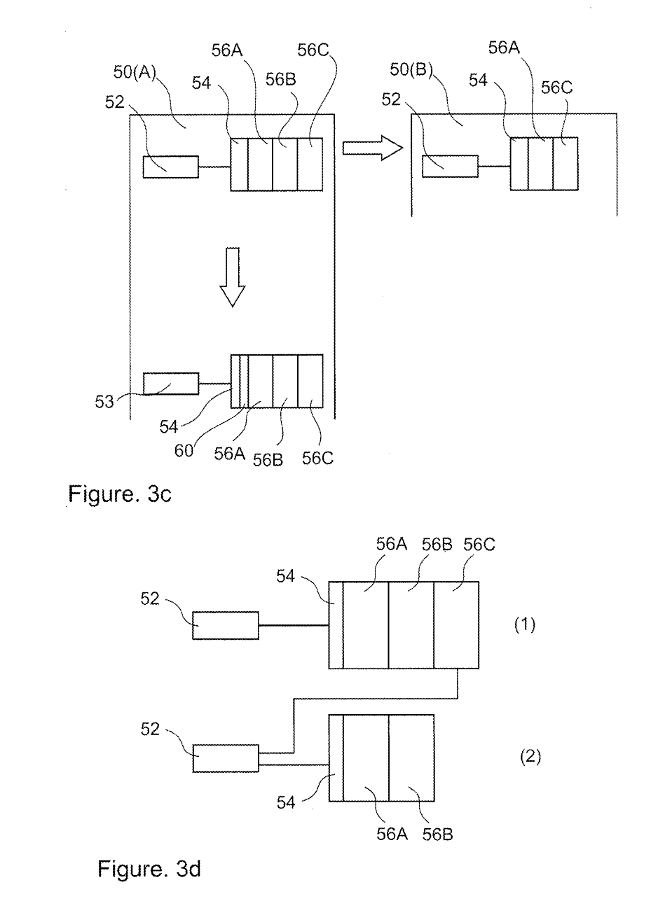

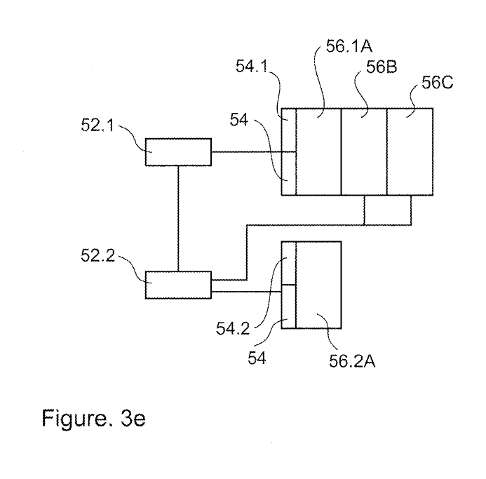

Referring to FIG. 3a, a basic structure of the data stored in the database 104 is illustrated. For example, the identification data 52 are uniquely associated with the information 56 and a name 54 of each object (1), (2), etc. of a set of objects for a user account 50, thus providing a direct relation of the stored information with the physical object having the respective identification tag attached thereto.

Optionally, as illustrated in FIG. 3b, the information is stored in a plurality of information subsets 56A, 56B, 56C with each information subset being associated with a respective access level 58A, 58B, 58C. A user account is then set up to provide access thereto for a plurality of users such as, for example, members of a family with the head of the family being the administrator of the account and other family members each having an access level to the account determined by the account administrator. The individual user authorization data of each family member is indicative of the access level determined by the administrator. The administrator provides/edits the information and associates access levels with information subsets 58A, 58B, 58C. Family members when providing their user authorization data indicative of an access level are then enabled to view the information subsets associated with their access level. For example, the administrator stores sensitive information such as an appraisal indicative of the value of an object or personal information in a designated information subset and limits the access thereto such that only the parents can view the information while the children are enabled to access the non-sensitive information stored in another information subset having a different access level associated therewith.

Storing the information in a plurality of information subsets 56A, 56B, 56C is also advantageous in situations when the object is, for example, sold or given to a family member. For example, the new owner of the object has an existing account 50(B) or a new account 50(B) is opened. In this case, the data are then transferred from one account 50(A) to another account 50(B) with the identification data 52 and the name 54 of the object being preserved, as illustrated in FIG. 3c. Having stored the information in a plurality of information subsets 56A, 56B, 56C enables the account holder of account 50(A) to restrict the transfer of information related to the object. For example, the account holder of account 50(A) has sold the object and does not wish the new owner to have access to personal information stored in information subset 56B. Optionally, other types of restrictions are enabled such as, for example, preventing alteration of the information or preventing access to the information before a predetermined date.

Optionally, after transfer, the name 54 and the information subsets 56A, 56B, 56C are kept in the account 50(A) associated with new identification data 53 indicating that the object related to the information has been transferred. Further optionally, information related to the transfer and the new owner of the object is stored in information subset 60. Alternatively, the name 54 and the information subsets 56A, 56B, 56C are deleted from the account 50(A) together with the identification data 52.

Further optionally, in case the object has been lost or destroyed, the name 54 and the information subsets 56A, 56B, 56C are kept in the account 50(A) associated with new identification data 53 indicating that the object related to the information has been lost.

Storing the information in a plurality of information subsets 56A, 56B, 56C is further advantageous if a portion of the information relates to more than one object. For example, as illustrated in FIG. 3d, the two objects (1) and (2) share the common information stored in information subset 56C. Here, instead of providing and storing the same information twice the information common to both objects is stored in information subset 56C and the identification data 52 of object (2) are additionally linked to the information subset 56C of object (1).

FIG. 3e illustrates the data structure for storing the information in case the object is a plurality of associated sub objects such as, for example, a dining room set comprising a sideboard, a table and a plurality of chairs. Here, a plurality of identification tags is provided such that each identification tag is associated with one sub object, as illustrated in FIG. 3e for two sub objects. The identification data 52.1, 52.2 of each identification tag can be indicative of the object and the sub object, which is also reflected in the name fields 54, 54.1, and 54.2 with 54 indicating the name of the set and 54.1, and 54.2 indicating a name of the respective sub object. Here, the identification data 52.1, 52.2 are associated with each other in order to link the sub objects. The information can again be stored in a plurality of information subsets 56.1A, 56.2A, 56B, 56C. For example, the information subsets 56.1A, 56.2A contain pictures of each individual sub object while the information subsets 56B and 56C contain information related to all sub objects which is stored with respect to sub object .1 and the identification data 52.2 of sub object .2 are additionally linked to the information subsets 56B and 56C of sub object .1.

Provision of RFID tags enables locating of a specific object. For example, as illustrated in FIG. 2c, after accessing the account as outlined in steps 12 to 16 hereinabove, a user is enabled to browse a list of the set of objects, for example, by object name, category, or picture, and selects—at 40—a specific object. The processor 108 then retrieves—at 42—the identification data associated with the object from the database 104 and provides—at 44—the same to the reader 126. The processor 128 of the reader determines the identification data from the received RF signals and compares the same with the identification data received from the processor 108. If the comparison is indicative of a match the processor generates a signal indicating that the object has been located—at 46.

The display data can be adapted for facilitating the provision of the information related to the object are generated for display in a human comprehensible fashion on a graphical user interface 120. For example, using standard web-based technology, the user is enabled to provide the information in various formats of text data, image data, audio data, video data, or a combination thereof. Optionally, the display data are indicative of a suggestion related to a type of information, for example, suggesting providing an image of the object, or a suggestion related to the content of the information, for example, suggesting providing information related to the history of the object. Further optionally, the suggestion is generated in dependence upon previously received information. For example, after providing the information that the object has been hand down from the parents, a suggestion is displayed asking for information, pictures, and stories about the parents, or after providing the information that the object is a work of art, a suggestion is displayed asking for information about the artist, provenance of the work of art, certificate of authenticity, appraisal, etc.

The method and system for storing information related to an object according to certain embodiments of the invention are implemented, for example, in a heritage service for documenting heirlooms and the family history associated therewith. The heritage service can be provided by a trusted entity having safeguards in place for ensuring provision of the service for future generations. For example, using data processing unit 106 the trusted entity displays information on a website about the heritage service provided via the computer network 112 to the client computer 114 and enables a user of the client computer 114 to open an account—which typically includes provision of personal information such as name, residential address, mailing address, telephone number, email account, etc.—and to pay an initial setup fee in a conventional manner. Upon opening the account the user is provided with account access information such as a username and a password. Furthermore, the user is provided with an initial set of identification tags 102 which is typically mailed to the user's mailing address. Additional identification tags 102 can then be ordered and purchased in a conventional manner after accessing the user account via the website. To continue the provided heritage service the user pays a renewal fee which is typically charged annually and can comprise a base renewal fee and a fee based on the number of additional identification tags 102.

Optionally, the heritage service provider generates additional revenue by providing additional services related to the object 1 in dependence upon the information provided by the user associated with the object 1 such as, for example, a list of antique dealers, art galleries, appraisers, restoration/repair services, auction houses, clubs of likeminded collectors, etc. in proximity of user's location. Such information is, for example, provided upon request by the user and is paid by the user and/or the businesses listed. Further optionally, the trusted entity has a promotional agreement with one or more of the businesses to provide users of the heritage service with a discount in return for being listed. A further source of revenue is targeted advertising by providing advertisement to the user based on the information provided by the user related to the object 1 and paid by the advertiser. For example, when the user describes an antique piece of furniture the information provided triggers display of advertisement related to appraisers, restoration/repair services, and antique dealers.

To ensure provision of the service for future generations, data processing and data storage is performed using backup systems placed in different secured locations while financial stability of the entity is ensured by providing a predetermined portion of the revenue to a trust fund which is invested in, for example, secured bonds. Furthermore, another predetermined portion of the revenue is used for updating the equipment, for example, providing users with replacement tags/readers in predetermined time intervals or in case of equipment failure, as well as for introducing new technologies which will emerge during the projected operation of future generations.

The present invention has been described herein with regard to certain embodiments. However, it will be obvious to persons skilled in the art that a number of variations and modifications can be made without departing from the scope of the invention as described herein.

What is claimed is:

1. A method for storing information related to an object comprising:
providing an identification tag for being attached to the object, the identification tag comprising identification data;
providing a database for storing therein information related to the object, the information being associated with the identification data;
providing a reader for retrieving the identification data from the identification tag;
attaching the identification tag to the object;
using the reader retrieving the identification data from the identification tag;
providing the identification data and the information related to the object; and
storing the information related to the object in the database.

2. The method according to claim 1 comprising:
comparing the identification data with identification data stored in the database;
if the comparison is indicative of a match, enabling provision of the information; and
receiving the information and associating the same with the received identification data.

3. The method according to claim 2 comprising:
using the reader retrieving the identification data from the identification tag;
providing the identification data;
comparing the identification data with identification data stored in the database; and
if the comparison is indicative of a match, enabling editing of the information associated with the identification data.

4. The method according to claim 3 comprising:
storing user authorization data in the database, the user authorization data being related to the identification data;
receiving user authorization data;
comparing the received user authorization data with the user authorization data stored in the database; and
if the comparison is indicative of a match, enabling access to the information associated with the identification data.

5. The method according to claim 4 wherein the information comprises a plurality of information subsets, wherein the user authorization data are indicative of an access level, and wherein access to a subset is dependent upon the access level.

6. The method according to claim 1 wherein the object is a plurality of associated sub objects and wherein the identification tag is a plurality of identification tags such that each identification tag is associated with one sub object.

7. The method according to claim 6 wherein the identification data of each identification tag are indicative of the object and the sub object.

8. The method according to claim 7 wherein the identification data of each identification tag are associated with the identification data of the other identification tags.

9. The method according to claim 1 wherein the object is one of a set of objects and wherein the identification tag is one of a set of identification tags with each identification tag being associated with a respective object of the set of objects.

10. The method according to claim 9 comprising:
storing user authorization data in the database, the user authorization data being related to a set of identification data, the set of identification data corresponding to the identification data of the set of identification tags;
receiving user authorization data;
comparing the received user authorization data with the user authorization data stored in the database; and
if the comparison is indicative of a match, enabling access to the information associated with the set of identification data.

11. The method according to claim 9 comprising:
associating the identification data related to an object of the set of objects with another set of objects.

12. The method according to claim 11 comprising:
storing data indicative of a restriction of access to the information related to the object after association with the other set of objects; and
enabling access to the information in dependence upon the data indicative of a restriction of access after association with the other set of objects.

13. The method according to claim 12 wherein the restriction comprises preventing alteration of the information.

14. The method according to claim 1 wherein a passive RFID tag and an active RF reader is provided.

15. The method according to claim 14 comprising:
retrieving the identification data;
providing the identification data to the RF reader; and
using the RF reader locating the object.

16. The method according to claim 1 comprising:
generating display data, the display data for facilitating provision of the information related to the object; and
providing the display data to a graphical user interface for display.

17. The method according to claim 16 wherein the display data are indicative of a suggestion related to at least one of a type and content of the information.

18. The method according to claim 17 comprising:
generating the suggestion in dependence upon previously received information.

19. A system for storing information related to an object comprising:
an identification tag for being attached to the object, the identification tag comprising identification data;
a reader for retrieving the identification data from the identification tag;
a database for storing therein information related to the object, the information being associated with the identification data;
a processor in communication with the reader and the database;
a user interface in communication with the processor; and
a non-transitory storage medium having stored therein executable commands for execution the processor, the processor when executing the commands performing:
receiving the identification data from the reader;
receiving the information related to the object from the user interface; and
associating the information related to the object with the identification data and providing the same to the database for storage therein.

20. The system according to claim 19 wherein the identification tag is a passive RFID tag and wherein the reader is an active RF reader.

21. The system according to claim 19 wherein the user interface is a graphical user interface and wherein the processor when executing the commands performs:
generating display data, the display data for facilitating provision of the information related to the object; and
providing the display data to the graphical user interface for display.
